(19) United States
(12) Patent Application Publication
(10) Pub. No.: US 2008/0022120 A1
(43) Pub. Date: Jan. 24, 2008

(54) System, Method and Computer Program Product for Secure Access Control to a Storage Device

(76) Inventors: Michael Factor, Haifa (IL); Dalit Naor, Tel Aviv -Jaffa (IL); Michael Rodeh, Haifa (IL); Julian Satran, Atlit (IL); Sivan Tal, Yokneam llit (IL)

Correspondence Address: IBM CORPORATION, T.J. WATSON RESEARCH CENTER, P.O. BOX 218, YORKTOWN HEIGHTS, NY, 10598, US

(21) Appl. No.: 11/422,096

(22) Filed: Jun. 5, 2006

(51) Int. Cl. H04K 1/00

(52) U.S. Cl. 713/184

(57) ABSTRACT

A method for accessing a storage device, the method includes: receiving, by storage device, a block based storage access command and cryptographically secured access control information; wherein the block based storage access command and the cryptographically secured access control information are associated with at least one fixed size block of data and with a client; processing at least a portion of the cryptographically secured access control information by using a secret key accessible to the storage device and to a security entity; and selectively executing the block based storage access command in response to a result of the processing.

### FIELD OF THE INVENTION

The present invention relates to methods, systems and computer program products for accessing a storage device.

### BACKGROUND OF THE INVENTION

Modern storage systems utilize the Small Computer System Interface (SCSI) protocol for transferring data between devices such as but not limited to host computers and storage units.

Block based commands (such as but not limited to SCSI block commands) are used to access block based storage units that store fixed size blocks of data. One or more blocks of data form a logical unit (LUN) while each fixed size block of data is addressed by a logical block address.

Block based SCSI commands do not have a built-in mechanism for access control. In other words, the block based SCSI command protocol does not provide a mechanism that can specify or enforce access control to a given fixed size block of data located at a certain logical block address.

The lack of such an access control mechanism poses a real limitation in storage area networks (SANs) that may connect multiple hosts to multiple storage units. In modern SANs a single (shared) storage device can store data of multiple clients in multiple logical units, where each client should have access to a subset of the logical units served by the storage device.

Many modern SANs are implemented by Fibre Channel switched fabric. FIG. 1 illustrates environment 80 that includes multiple computers 10-18, multiple servers 30-34, a switched fabric 40 and multiple storage devices 50-56. Computers 10-18 are connected to servers 30-34 via network 20. Network 20 is also connected to the Internet 26 via firewall 22.

Each server out of servers 30-34 is connected via one or more Host Bus Adapters (HBA) to switched fabric 40 while storage devices 50-56 are connected to switched fabric switch 40 via one or more FC Host Adapter (HA).

A computer out of computers 10-18 can send a request to receive a file to a server out of servers 30-34. That server can receive the request and in response generate one or more requests to receive one or more fixed size blocks of data stored within a storage system out of storage devices 50-56. The server may generate one or more block based SCSI commands to access one or more fixed size blocks of data.

In these SANs zoning and alternatively or additionally logical unit masking are used to provide access control mechanisms. These mechanisms are based on limiting the connectivity between HBA and HA ports, and the accessibility of logical units through specific HA ports and HBA ports. Fabric zoning includes dividing the Fiber Channel switched fabric to zones, where a fabric node can only communicate with another fabric node if the two nodes belong to a common zone. The nodes are identified either by their Fiber Channel fabric address or by their world wide port name (WWPN). Logical unit masking includes maintaining access control lists specifying host HBA ports that can access storage logical units.

N Port ID Virtualization (NPIV) is a standard for virtualizing the HBA port, thus enabling zoning and LUN masking based on virtual machines rather than on physical machines.

The Fibre Channel Security Protocols (FC-SP) standard (owned by technical committee T11) specifies standard for providing a secure channel of data exchange between nodes in the fabric.

Fabric zoning and logical unit masking are not adequately adapted to modern computing environments in which one or more virtual machines can be hosted by a single host and especially in environments that dynamically assign virtual machines (or virtual machine portions) to host computers.

Object based storage device (OSD) systems organize data as variable sized objects. Data elements are not accessed by logical block addresses but rather by object identification information. The ANSI T10 OSD standard defines an object based access control mechanism that is not adapted to support fixed sized data elements and does not use block based SCSI commands.

Most existing systems as well as various modern systems are not OSD systems. They can be accessed by block based storage access commands. There is a need to provide efficient methods, systems and computer program products for accessing block based storage devices.

### SUMMARY OF THE PRESENT INVENTION

A method for accessing a storage device, the method includes: receiving, by storage device, a block based storage access command and cryptographically secured access control information; wherein the block based storage access command and the cryptographically secured access control information are associated with at least one fixed size block of data and with a client; processing at least a portion of the cryptographically secured access control information by using a secret key accessible to the storage device and to a security entity; and selectively executing the block based storage access command in response to a result of the processing.

Conveniently, the block based storage access command is associated with at least one fixed size block of data and wherein the cryptographically secured access control information is associated with a logical unit that includes the at least one fixed size block of data and additional fixed size blocks of data.

Conveniently, the cryptographically secured access control information includes capability information and a validation tag; wherein the processing includes authenticating at least the capability information by using the validation tag and the secret key.

Conveniently, the method further includes sending the secret key using a first link while receiving the block based storage access command over a second link.

Conveniently, the block based storage access command is a block based Small Computer System Interface (SCSI) command.

Conveniently, the block based storage access command is a block based General Parallel File System Virtual Shared Disk (GPFS/VSD) command.

Conveniently, the block based storage access command is a Network Block Device (NBD) command.

### BRIEF DESCRIPTION OF THE DRAWINGS

The present invention will be understood and appreciated more fully from the following detailed description taken in conjunction with the drawings in which:

FIG. 1 illustrates a prior art environment;

FIG. 2 illustrates an environment according to an embodiment of the invention;

FIG. 3 illustrates an environment according to an embodiment of the invention;

FIG. 4 illustrates logical connections between various entities according to an embodiment of the invention;

FIG. 5 illustrates a method for accessing a storage device according to an embodiment of the invention;

FIG. 6 illustrates a method for accessing a storage device according to an embodiment of the invention; and

FIG. 7 illustrates a method for accessing a storage device according to an embodiment of the invention.

### DETAILED DESCRIPTION OF THE DRAWINGS

Methods, systems and computer program products for accessing a block-based storage device. The access can be granted or denied based upon an access control policy that defines access rights of a client to one or more fixed size blocks of data. The one of more fixed size blocks of data can form a logical unit or a portion of a logical unit. The definition of a client and access control can vary depending on the implementation. The access rights of a client can be changed dynamically. A client can be a physical server, a virtual machine or another logical entity.

The mentioned below devices, methods and computer program products are inherently logical rather than physical. The entities that play the client role are flexible, and can be chosen for any implementation in a rather arbitrary way.

The block-based approach uses simpler and much smaller storage access commands than the object-based approach. The amount of meta-data required for describing an object is much larger than the amount of metadata required for describing one or more blocks.

For convenience of explanation some of the following examples will relate to SCSI commands. Those of skill in the art will appreciate that the invention is applicable to other block based storage access commands. For example, the block based storage access commands can be General Parallel File Storage (GPFS) commands used in GPFS systems to access Virtual Shared Disks (VSD). GPFS provides high performance I/O by “stripping” fixed size blocks of data from individual files across multiple disks (or multiple storage devices) and reading and/or writing these blocks in parallel. In addition GPFS can read or write large blocks of data in a single I/O operation.

The virtual shared disk (VSD) components of GPFS support three configurations—a storage access network (SAN) attached model, the VSD server model and a hybrid model. For simplicity of explanation the SAN attached model is illustrated. Those of skill in the art will appreciate that the illustrated methods, systems and computer program products can be applied to any of these three configurations.

Yet for another example, the illustrated methods, systems and computer program products can be applied when using the Network Block Device (NBD) protocol. NBD simulates a block device, such as a hard disk or hard-disk partition, on the local client, but connects across the network to a remote server that provides the real physical backing. NBD can be used for transferring block based commands from a NBD client to a NBD device residing in a remote server (that in turn executes the block based commands) and in response receiving status and data. The NBD protocol operates above the SCSI layer, at the higher Unix/Linux block device layer, thus eliminating the need to convert generic block commands to block-based SCSI commands before sending them over the network to the storage system.

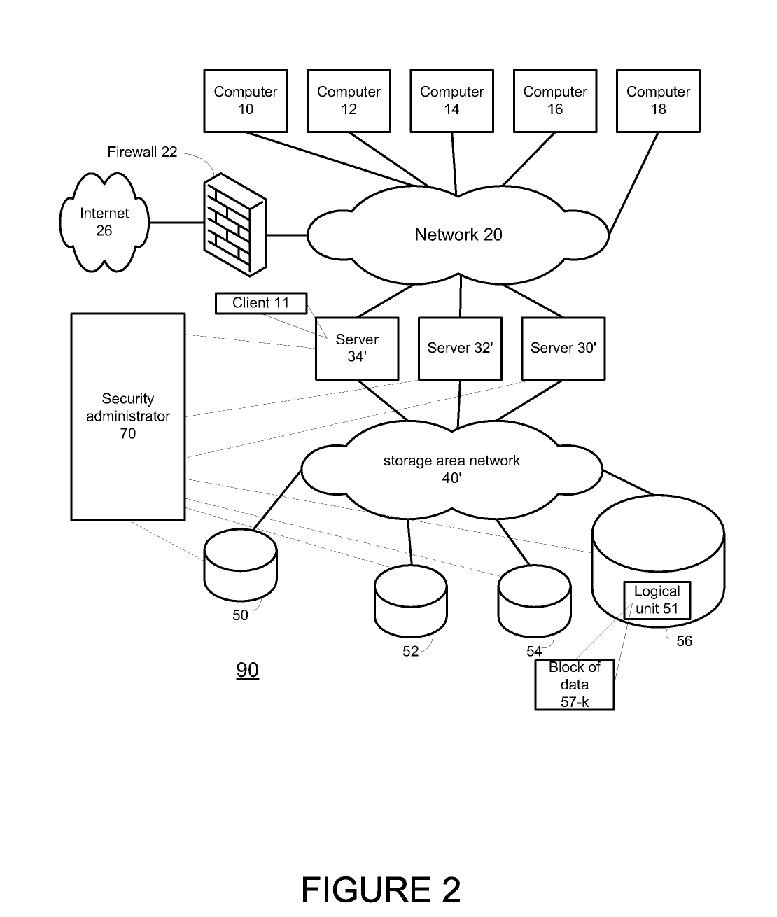

FIG. 2 illustrates environment 90 according to an embodiment of the invention.

Environment 90 includes security administrator 70 that is adapted to participate in the enforcement of an access control policy. In addition, servers 30′-34′ are further adapted to generate block based commands that are associated with cryptographically secured access control information.

Typically, the cryptographically secured access control information is associated with a logical unit or a portion of the logical unit that may include many fixed size blocks, while a block based storage access command relates to one or more fixed size blocks within that logical unit or within a portion of the logical unit.

It is noted that the cryptographically secured access control information as well as the access control information does not necessarily include a client identifying information. Conveniently, the security administrator selects which access control information to send to the client in response to the identity of the client, but said identity is not included in the access control information and is not provided in the cryptographically secured access control information generated by the client.

Environment 90 includes multiple computers 10-18, multiple servers 30′-34′, a storage area network 40′ (that may be a switched fabric SAN) and multiple storage devices 50-56. Computers 10-18 are connected to servers 30′-34′ via network 20. Network 20 is also connected to the Internet 26 via firewall 22.

It is noted that the security administrator 70 can be located at different locations and can be connected to different computers, servers and storage units in various manners.

It is further noted that multiple security administrators can be allocated per a group of servers and storage devices. It is further noted that the security administrator can be characterized by a centralized architecture or by a distributed architecture and that various portions of the security administrator can reside in different servers, computers and networks. For example, a security administrator can be embedded in a server or a in computer that hosts one or more virtual machines, and can take the form of a distributed application that is being run as distributed application.

According to an embodiment of the invention the security administrator 70 can be embedded in one or more server and/or in one or more storage devices.

Security administrator 70 can be connected to storage area network 40′ but this is not necessarily so. The security administrator can be connected to servers 30′-34′ and to storage devices 50-56 via links that do not belong to storage access network 40′. The dashed lines that are connected between security administrator 70 between servers 30′-34′ and storage devices 50-56 represent these links.

It is assumed security administrator 70 is a trusted entity. Accordingly, it can act according to a predefined protocol; it can appropriately store secret keys and can enforce an access control policy. Storage devices 50-56 are also trusted. It is assumed that each storage device is capable of following the protocol and to appropriately store secret keys.

A server, such as server 34′, can host a client (for example client 11) that wishes to perform a certain operation (such as but not limited to a read operation or a write operation) on a certain fixed size block of data (for example, data block 57-k that belongs to logical unit 51 that is stored in storage device 56).

Client 11 can request a credential from security administrator 70. Assuming that client 11 is authorized to perform the requested operation on data block 57-k, the security administrator 70 will reply by returning to client 11 a credential that includes capability information and a capability key.

Conveniently, the credential is independent on the identity of the client or its location. The credential can be used by the client to access one or more fixed size blocks of data in logical unit 51, from any physical location, using any networking mechanism to transport the block based commands and data. Accordingly, a credential-based solution is suited for a dynamic server environment, and also makes it independent on the network technology used as transport layer.

The capability information defines the access rights of client 11 in relation to data block 57-k but is typically defined per logical unit. It is noted that it can be defined per a portion of a logical unit wherein the portion includes one or more fixed size blocks of data. The capability information is public. It can be a bitmap (where each bit value determines whether a certain type of operation is allowed) but it can also have other formats.

The capability key is secret. It can be computed by applying a mathematical function (such as a cryptographic one way function) on the capability information and on a secret key that is shared between security administrator 70 and storage device 56.

Client 11 receives the capability key and the capability information and computes a validation tag, by using the capability key. The structure and the usage of the validation tag depend upon the security level of the transport layer used to convey information between client 11 and storage device 56.

For example, if storage area network 40′ utilizes a security mechanism that provides a secure channel such as FC-SP secure channel then the validation tag can be sent from client 11 to storage device 56. If, for example storage area network 40′ is less secure then the validation tag and/or additional information can be computed such as to avoid a replay of the credential before being sent from client 11 to storage device 56.

Client 11 then sends to storage device 56 the block based storage access command as well as the capability information and the validation tag.

Storage device 56 receives the block based storage access command, the capability information and the validation tag and uses the validation tag as well as the secret key to authenticate at least the capability information.

If the validation is successful the requested command is executed. Else—the block based storage access command is rejected.

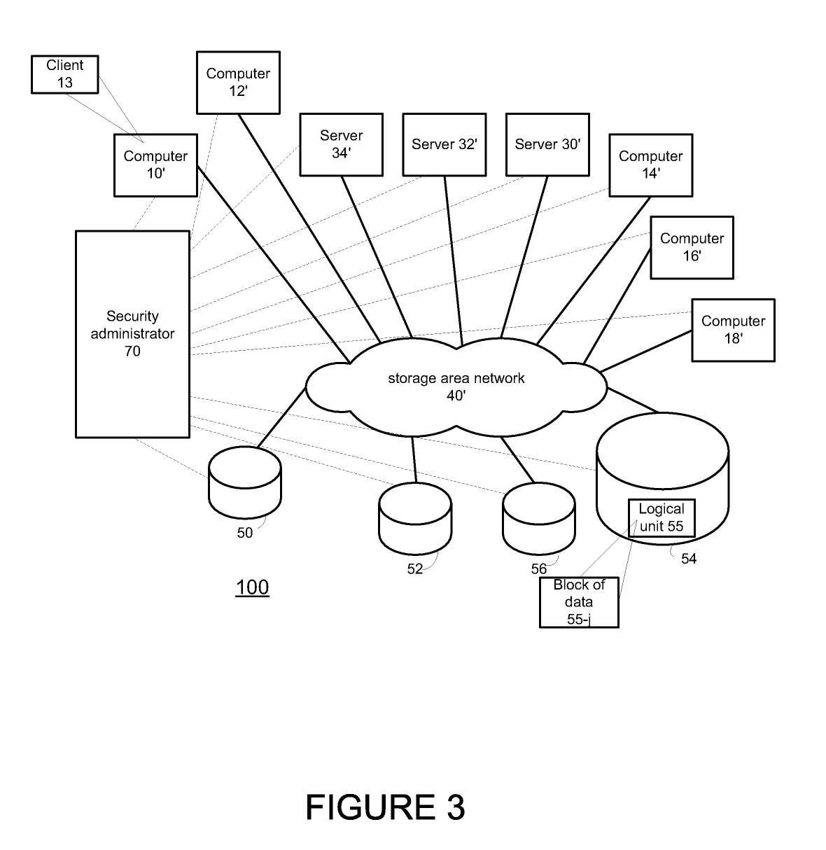

FIG. 3 illustrates environment 100 according to an embodiment of the invention.

Computers 10′-18′ are connected to storage area network 40′. Accordingly, they can host a client that can access one or more storage devices. This client can communicate with the security administrator, compute a validation tag and send a block based storage access command as well as cryptographically secured access control information to the storage device.

For simplicity of explanation it is assumed that client 13 (hosted on computer 10′) wishes to perform a certain operation (such as but not limited to a read operation or a write operation) on a fixed size block of data 55-j that belongs to logical unit 55 and that logical unit 55 is stored at storage device 54.

Client 13 will request a credential from security administrator 70. Assuming that client 13 is authorized to perform the requested operation on data block 55-j then security administrator 70 will reply by returning to client 13 a credential that includes capability information and a capability key.

The capability information defines the access rights of client 13 in relation to data block 55-j or in relation to the whole logical unit 55.

The capability key can be computed (by security administrator 70) by applying a mathematical function (such as a cryptographic one way function) on the capability information and on a secret key that is shared between security administrator 70 and storage device 54.

Client 13 receives the capability key and the capability information and computes a validation tag, by using the capability key. The structure and the usage of the validation key depend upon the security level of the link between client 13 and storage device 54.

Client 13 then sends to storage device 54 a block based storage access command that should be executed by storage device 54 as well as the capability information it received from security administrator 70 and the validation tag it computed.

Storage device 56 receives the block based storage access command, the capability information and the validation tag (or information representative of the validation tag) and uses the validation tag as well as the secret key to authenticate at least the capability information.

If the validation is successful the requested command is executed. Else—the block based storage access command is rejected.

Conveniently, if the block based storage access command is a block based SCSI command then it can be a SCSI I/O command, storage controller command, SCSI command for Copy Services, and SCSI control type command.

SCSI I/O commands can include READ commands and WRITE commands in their various forms as well as SCSI commands that can be viewed as implicit Write (for example a FORMAT_UNIT SCSI command). For these I/O SCSI commands, a rich set of access rights may be defined, according to the set of operations targeted at a particular logical unit.

Controller's commands can include the REPORT LUNS command. For such commands, the capability information should specify the Logical Unit on which the command is targeted (for example, LUN zero). Such capability enforces a Yes/No policy (whether a client may execute the specified command on the controller).

SCSI commands for Copy Services may be supported by block devices by using the standard EXTENDED COPY command or by use of vendor-specific command types and the mechanism would apply to them as well. The mechanism may also be used to enforce access to control type commands such as INQUIRY and SEND DIAGNOSTIC.

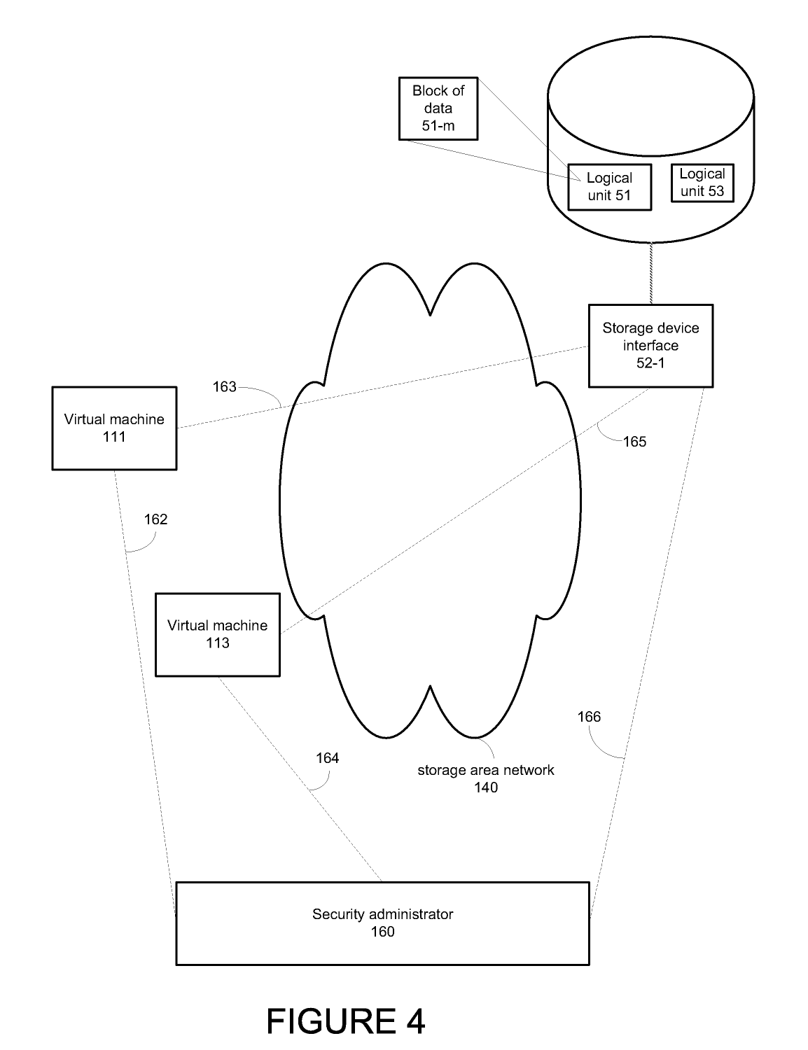

FIG. 4 illustrates logical connections between various entities according to an embodiment of the invention.

FIG. 4 illustrates clients such as virtual machines 111 and 113, storage area network 140, security administrator 160, a storage device interface 52-1, and two logical units 51 and 53 that are stored in storage device 52.

It is noted that the various logical entities, including clients and logical units can be hosted or stored in physical devices that can be connected to each other in various manners and that storage area network 140 can be preceded or followed by one or more networks such as but not limited to network 20.

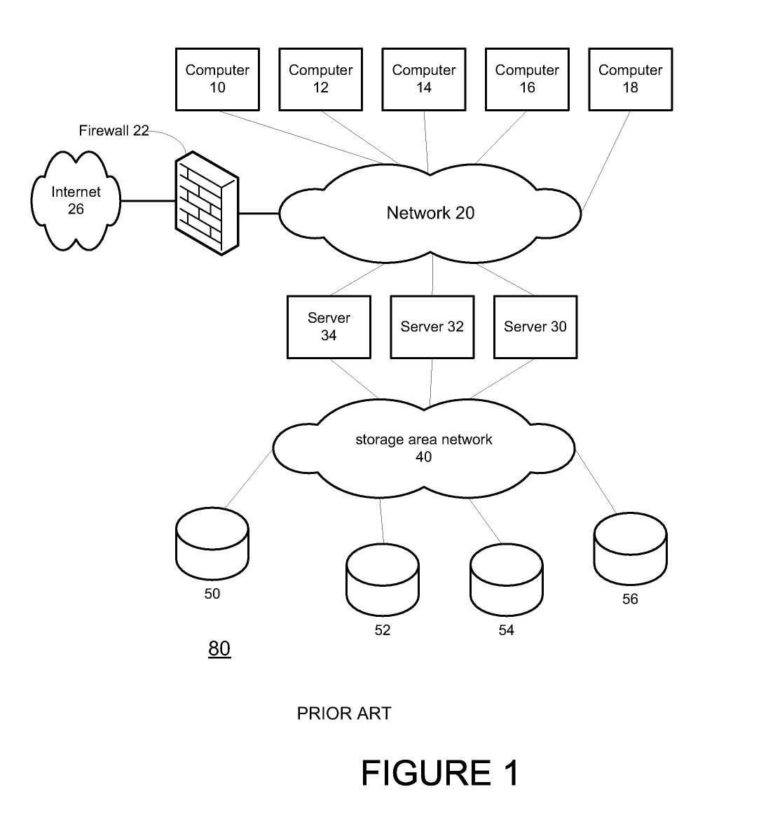

Conveniently, the virtual machines can be hosted by a computer out of computers 10-18 of FIG. 1, or hosted by a server out of servers 30′-34′. Virtual machines 111 and 113 communicate with storage device 52 by using block based storage access commands that are associated with cryptographically secured access control information.

Virtual machine 111 can access a fixed size block of data such as block 51-m by a sequence of stages. It first sends to security administrator 70 a request to receive access control information associated with virtual machine 111 and with block 51-m (or with logical unit 51).

After receiving the access control information from security administrator 160, virtual machine 111 generates cryptographically secured access control information that is associated with a block based storage access command. Said information and command (also referred to wrapped block based storage access command) are sent over storage area network 140 to storage device 52 and especially to storage device interface 52-1. Storage device interface 52-1 uses the secret key to determine whether the block based storage access command should be executed.

Conveniently, virtual machine 111 sends the wrapped block based storage access command over a first link (such as link 163) while it exchanges information with security administrator 160 over another link (such as link 162).

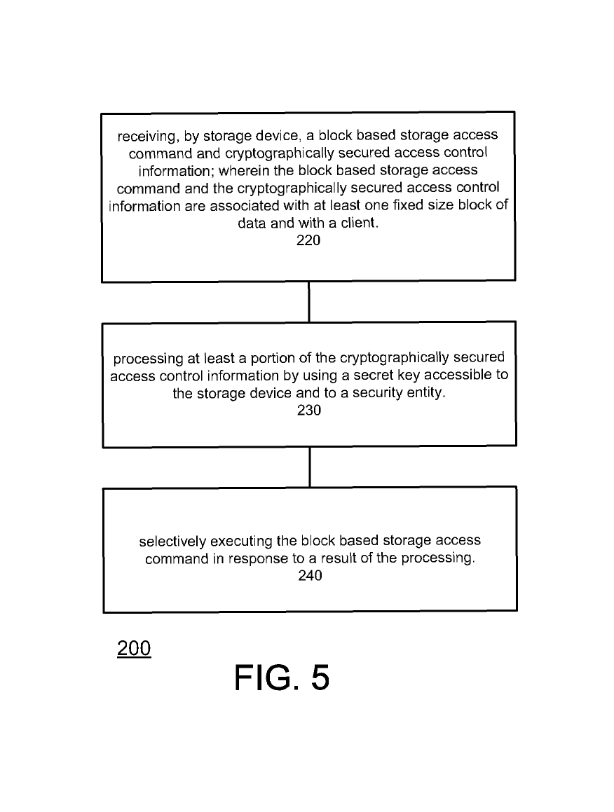

FIG. 5 illustrates method 200 for accessing a storage device according to an embodiment of the invention.

The various stages of method 200 can be implemented by a storage device, but this is not necessarily so.

Method 200 starts by stage 220 of receiving, by a storage device, a block based storage access command and cryptographically secured access control information. The block based storage access command and the cryptographically secured access control information are associated with one or more fixed size logical block.

Conveniently, the block based storage access command is associated with one or more fixed size blocks and wherein the cryptographically secured access control information is associated with a logical unit or a portion of a logical unit that may include multiple fixed size blocks of data including the one or more fixed size blocks of data as well as additional fixed size blocks of data.

Stage 220 is followed by stage 230 of processing at least a portion of the cryptographically secured access control information by using a secret key accessible to the storage device and to a security entity. Conveniently, the block based storage access command and the secured access control information is received over a communication link that differs from a communication link over which the shared secret is sent.

Conveniently, the cryptographically secured access control information includes capability information and a validation tag and stage 230 includes authenticating at least the capability information by using the validation tag and the secret key.

Stage 230 is followed by stage 240 of selectively executing the block based storage access command in response to a result of the processing. Thus, the block based storage access command is executed if the authentication was successful.

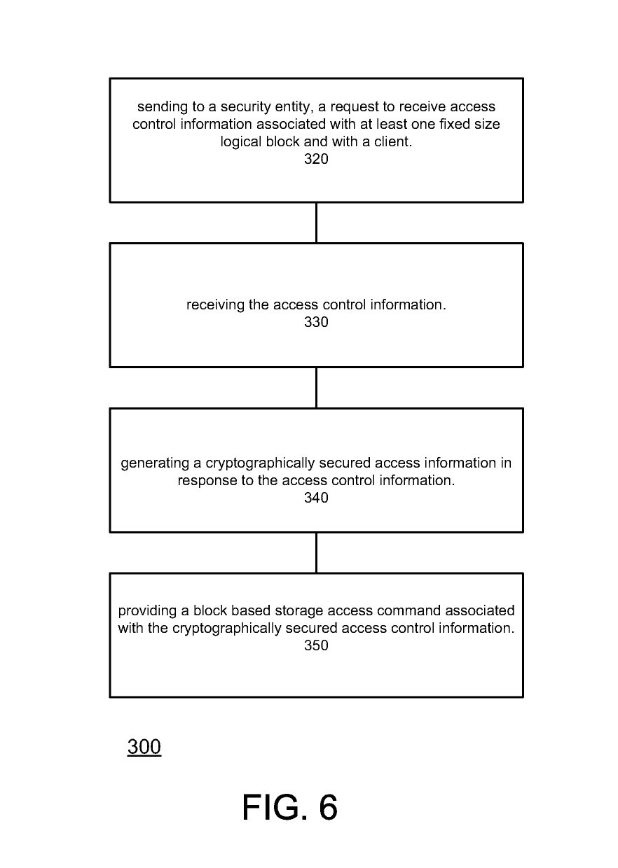

FIG. 6 illustrates method 300 for accessing a storage device according to an embodiment of the invention.

The various stages of method 300 can be implemented by a client, but this is not necessarily so.

Method 300 starts by stage 320 of sending to a security entity, a request to receive access control information associated with one or more fixed size logical blocks and with a client.

Stage 320 is followed by stage 330 of receiving the access control information.

Stage 330 is followed by stage 340 of generating a cryptographically secured access information in response to the access control information. Stage 340 usually includes utilizing a capability key provided by the security entity.

Stage 340 is followed by stage 350 of providing a block based storage access command associated with the cryptographically secured access control information.

Conveniently, stage 320 include utilizing a first link while stage 340 includes utilizing a second link.

Conveniently stage 340 includes providing the block based storage access command over a storage area network.

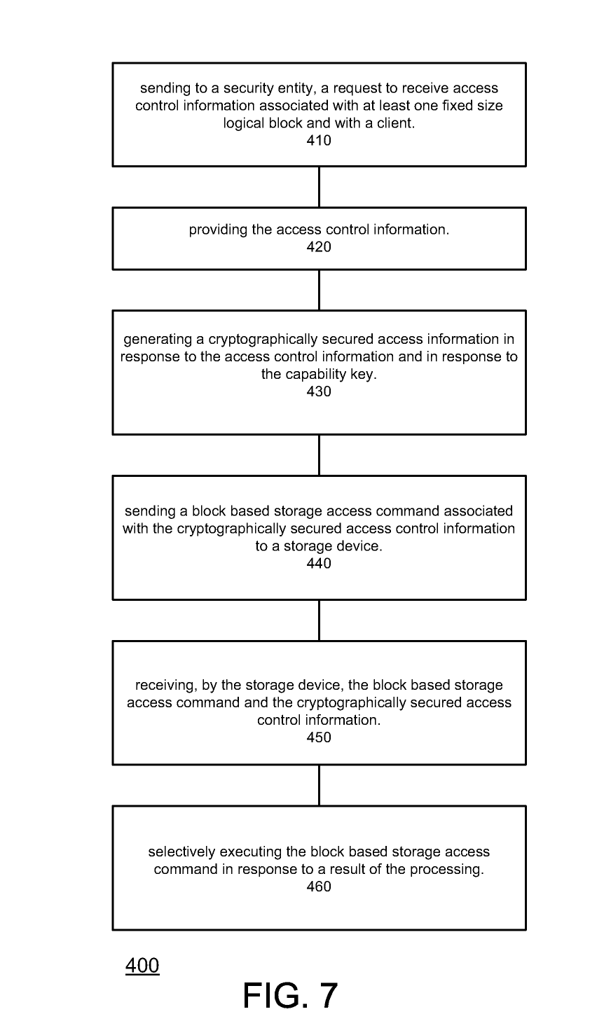

FIG. 7 illustrates method 400 for accessing a storage device according to an embodiment of the invention.

The various stages of method 400 can be implemented by a combination of entities such as a client, a security entity and a storage device but this is not necessarily so.

Method 400 starts by stage 410 of sending to a security entity, a request to receive access control information associated with at least one fixed size data block and with a client. The at least one fixed size data block can form a logical unit or a portion of the logical unit.

Stage 410 is followed by stage 420 of providing the access control information. Stage 420 also includes providing additional information such as a capability key.

Stage 420 is followed by stage 430 of generating cryptographically secured access information in response to the access control information and in response to the capability key.

Stage 430 is followed by stage 440 of sending a block based storage access command associated with the cryptographically secured access control information to a storage device.

Stage 440 is followed by stage 450 of receiving, by the storage device, the block based storage access command and the cryptographically secured access control information. Stage 450 also includes processing at least a portion of the cryptographically secured access control information by using a secret key accessible to the storage device and to a security entity.

Stage 450 is followed by stage 460 of selectively executing the block based storage access command in response to a result of the processing.

Various exemplary formats of a wrapped SCSI command are illustrated below. A block based SCSI command can include command parameters and data: [Command parameters, data].

If, for example the underlying transport layer is secured and guarantees message integrity and authenticity, anti-replay and protection against man-in-the-middle attacks, then the wrapped SCSI command can be [Command parameters, capability information, validity] Data, whereas the validity tag can be F_{Kcap}(security token). The security token is a unique identifier of the transport secure channel that is chosen by the storage device. K_{cap} is the capacity key and function F is the mathematical function applied on the capability key.

If, for example, the underlying transport is not secured then the wrapped SCSI command will be: [Command parameters, capability information, Data] [F_{K cap}(security token, Command parameters, capability information, Data)] where here the security token can be a unique per-command nonce and possibly other fields for anti-replay. F_{K cap} represents a cryptographic function that is applied by using the credential key.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for accessing a storage device, the method comprises:
receiving, by storage device, a block based storage access command and cryptographically secured access control information; wherein the block based storage access command and the cryptographically secured access control information are associated with at least one fixed size block of data and with a client;
processing at least a portion of the cryptographically secured access control information by using a secret key accessible to the storage device and to a security entity; and
selectively executing the block based storage access command in response to a result of the processing.

2. The method according to claim 1 wherein the cryptographically secured access control information is associated with at least a portion of a logical unit that comprises the at least one fixed size block of data and additional fixed size blocks of data.

3. The method according to claim 1 wherein the cryptographically secured access control information comprises capability information and a validation tag; wherein the processing comprises authenticating at least the capability information by using the validation tag and the secret key.

4. The method according to claim 1 further comprising receiving the secret key using a first link while receiving the block based storage access command over a second link.

5. The method according to claim 1 wherein the block based storage access command is a block based Small Computer System Interface (SCSI) command.

6. The method according to claim 1 wherein the block based storage access command is a block based General Parallel File System Virtual Shared Disk (GPFS/VSD) command.

7. A method for accessing a storage device, the method comprises:
sending to a security entity, a request to receive access control information associated with at least one fixed size logical block and with a client;
receiving the access control information and capability key; generating a cryptographically secured access information based on the received access control information and capability key; and
providing a block based storage access command associated with the cryptographically secured access control information.

8. The method according to claim 7 wherein the sending comprises utilizing a first link while the providing comprises utilizing a second link.

9. The method according to claim 7 wherein the block based storage access command is a block based Small Computer System Interface (SCSI) command.

10. The method according to claim 7 wherein the block based storage access command is a block based General Parallel File System Virtual Shared Disk (GPFS/VSD) command.

11. A computer program product comprising a computer usable medium including a computer readable program, wherein the computer readable program when executed on a computer causes the computer to:
receive a block based storage access command and cryptographically secured access control information; wherein the block based storage access command and the cryptographically secured access control information are associated with at least one fixed size logical block and with a client;
process at least a portion of the cryptographically secured access control information by using a secret key accessible to the storage device and to a security entity; and
selectively execute the block based storage access command in response to a result of the processing.

12. The computer program product according to claim 11, wherein the storage based access command is associated with at least one fixed size block of data and wherein the cryptographically secured access control information is associated with a logical unit that comprises the at least one fixed size block and additional fixed size blocks of data.

13. The computer program product according to claim 11, wherein the cryptographically secured access control information comprises capability information and a validation tag; wherein the computer readable program when executed on a computer causes the computer to authenticate at least the capability information by using the validation tag and the secret key.

14. The computer program product according to claim 11, wherein the computer readable program when executed on a computer causes the computer to receive the secret key using a first link while receiving the block based storage access command over a second link.

15. The computer program product according to claim 11 wherein the block based storage access command is a block based Small Computer System Interface (SCSI) command.

16. The computer program product according to claim 11 wherein the block based storage access command is a block based General Parallel File System Virtual Shared Disk (GPFS/VSD) command.

17. A computer program product comprising a computer usable medium including a computer readable program, wherein the computer readable program when executed on a computer causes the computer to:
send to a security entity, a request to receive access control information associated with at least one fixed size block of data and with a client;
receive the access control information and a capability key;
generate a cryptographically secured access information based on the access control information and the capability key; and
provide a block based storage access command associated with the cryptographically secured access control information.

18. The computer program product according to claim 17 wherein the computer readable program when executed on a computer causes the computer to send a request to receive access control information associated with at least one fixed size block of data over a first link and to provide a block based storage access command associated with the cryptographically secured access control information over a second link.

19. The computer program product according to claim 17 wherein the block based storage access command is a block based Small Computer System Interface (SCSI) command.

20. The computer program product according to claim 17 wherein the block based storage access command is a block based General Parallel File System Virtual Shared Disk (GPFS/VSD) command.

21. A system having data access capabilities, the system comprises:
a storage device that comprises a storage medium and a storage device interface that is adapted to receive, a block based storage access command and cryptographically secured access control information; wherein the block based storage access command and the cryptographically secured access control information are associated with at least one fixed size logical block and with a client; wherein the storage device is adapted to process at least a portion of the cryptographically secured access control information by using a secret key accessible to the storage device and to a security entity and to selectively execute the block based storage access command in response to a result of the processing.

22. The system according to claim 21 wherein the cryptographically secured access control information is associated with at least a portion of a logical unit that comprises the at least one fixed size block and additional fixed size blocks.

23. The system according to claim 21 wherein the cryptographically secured access control information comprises capability information and a validation tag; wherein the storage device is adapted to authenticating at least the capability information by using the validation tag and the secret key.

24. The system according to claim 21 adapted to receive the secret key using a first link while receive the block based storage access command over a second link.

25. The system according to claim 21 wherein the block based storage access command is a block based Small Computer System Interface (SCSI) command.

26. The system according to claim 22 wherein the block based storage access command is a block based General Parallel File System Virtual Shared Disk (GPFS/VSD) command.

27. A system comprising a host computer and an interface; wherein the interface is adapted to receive access control information; wherein the host computer is adapted to host at least a portion of a client that is adapted to send to a security entity, a request to receive the access control information associated with at least one fixed size block of data and with a client, and a capability key; generate a cryptographically secured access information in response to the access control information and the capability key; and provide a block based storage access command associated with the cryptographically secured access control information.

28. The system according to claim 27 wherein the system is adapted to utilize a first link for sending the request and is further adapted to utilize a second link for providing the block based storage access command.

29. The system according to claim 27 wherein the block based storage access command is a block based Small Computer System Interface (SCSI) command.

30. The system according to claim 27 wherein the block based storage access command is a block based General Parallel File System Virtual Shared Disk (GPFS/VSD) command.

31. A method for accessing a storage device, the method comprising:
sending to a security entity, a request to receive access control information associated with at least one fixed size block of data and with a client;
providing the access control information and a capability key;
generating a cryptographically secured access information based on the access control information and the capability key;
sending a block based storage access command associated with the cryptographically secured access control information to a storage device;
receiving, by the storage device, the block based storage access command and the cryptographically secured access control information;
processing at least a portion of the cryptographically secured access control information by using a secret key accessible to the storage device and to a security entity; and
selectively executing the block based storage access command in response to a result of the processing.

32. The method according to claim 31 wherein the cryptographically secured access control information comprises capability information and a validation tag; wherein the processing comprises authenticating at least the capability information by using the validation tag and the secret key.

33. The method according to claim 31 further comprising receiving the secret key using a first link while receiving the block based storage access command over a second link.

34. The method according to claim 31 wherein the block based storage access command is a block based Small Computer System Interface (SCSI) command.

35. The method according to claim 31 wherein the block based storage access command is a block based General Parallel File System Virtual Shared Disk (GPFS/VSD) command.
